(19) United States
(12) Patent Application Publication
(10) Pub. No.: US 2014/0195337 A1
(43) Pub. Date: Jul. 10, 2014

(54) BROWSER INTERFACE FOR ACCESSING SUPPLEMENTAL CONTENT ASSOCIATED WITH CONTENT PAGES

(71) Applicant: Amazon Technologies, Inc., (US)

(72) Inventors: Brett Richard Taylor, Bainbridge Island, WA (US); Ameet Nirmal Vaswani, Seattle, WA (US); Peter Frank Hill, Seattle, WA (US); Jason Daniel Landry, Seattle, WA (US); Ranganath Atreya, Kirkland, WA (US); Yang Xu, Seattle, WA (US); Charley Ames, Seattle, WA (US); Christopher James Sullins, Seattle, WA (US)

(73) Assignee: AMAZON TECHNOLOGIES, INC., Reno, NV (US)

(21) Appl. No.: 13/737,760

(22) Filed: Jan. 9, 2013

(51) Int. Cl. G06F 3/0488

(52) U.S. Cl. CPC G06F 3/0488; G06Q 30/0277
USPC 705/14.45; 705/14.73; 705/14.71

(57) ABSTRACT

A user of a computing device may view a content page on a display of a computing device. One aspect of the disclosure is a browser user interface than enables the user to flip the content page (or portion thereof) over (e.g., via a touchscreen gesture) to view supplemental content, such as metadata, associated with the content page (or portion thereof). While viewing the metadata on the back side of the content page in some embodiments, the user can perform a second or reverse flip operation to return to the original page. The user may be presented with options to flip the page backward and forward multiple times to view multiple flipped pages presenting additional supplemental content. The supplemental content may include virtually any information in which the user may be interested and/or that is related or similar to the content page.

### CROSS-REFERENCE TO RELATED APPLICATIONS

This application is related to commonly owned, U.S. patent application Ser. No. 13/069,193, entitled Presenting Supplemental Content, filed Mar. 22, 2011 (“the '193 application”), the entirety of which is incorporated herein by reference.

### BACKGROUND

The continued proliferation of digital content items has led to an increase in the availability of such content items, as well as an increase in the availability of electronic computing devices used for consuming these content items. For instance, users now consume electronic books, videos, songs, documents, webpages, images, applications, etc. on an assortment of stationary and/or portable computing devices. As the number of content items and devices continues to increase, users become increasingly interested in enhancing their experiences while consuming these content items. For example, while consuming an item of digital content, users are often naturally curious about information that is related to the content item and/or that is similar to the content item. However, given the vast amount of information that can be considered related or similar to the content item being consumed by the user, a typical user would generally prefer a user interface which enables the user to efficiently and intuitively access such information.

### BRIEF DESCRIPTION OF DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a pictorial diagram of a computing device having a display upon which a content item is presented in a first page and upon which supplemental content is presented in a second, flipped page in response to a user interaction with the computing device, the user interaction occurring while the content item is being presented in the first page on the display.

FIG. 2 is a pictorial diagram of a computing device having a display upon which one or more content items are presented in a first page, and upon which supplemental content is presented in one or more flipped panels in the first page in response to a user interaction with the computing device, the user interaction occurring while the content items are being presented in the first page on the display.

FIG. 3 is a block diagram illustrative of an operating environment in which supplemental content may be provided to a computing device for presentation in a flipped page or pane according to one embodiment.

FIG. 4 is a flow diagram of an illustrative process for obtaining supplemental content for presentation in a flipped page or pane.

### DETAILED DESCRIPTION

Aspects of the present disclosure relate to presenting one or more content items in a first page on a display of a computing device and automatically presenting supplemental content in a second, “flipped” page on the display following detection of a user interaction with the computing device. One aspect of the disclosure is a browser user interface than enables a user to flip a content page over (e.g., via a touchscreen gesture) to view supplemental content (e.g., page metadata) associated with the page. While viewing the supplemental content on the back side of the page in some embodiments, the user can perform a second or reverse flip operation to return to the original page. The content items presented in the first page may, for example, be optimized for aesthetic reasons (e.g., due to screen resolution limitations such as limited screen “real estate”), or may simply be presented in their original form. However, when the user interacts with the computing device (e.g., via a user gesture to “flip” the page), supplemental content may be presented in a flipped page on the display of the computing device. The flipped page (which may also be referred to herein as the back side of the page) may present, for example, the “flip” or “back” side of the first page. In some embodiments the flipped page may replace the first page on the display. The flipped page may also present, for example, the content items as presented in the first page, with one or more portions, or panels, of the first page flippable to present supplemental content corresponding to the content items presented in the first page. The supplemental content may include virtually any associated information in which the user may be interested and/or that is related or similar to the initial content. Accordingly, rather than presenting such supplemental content upon an affirmative request or search by the user, the supplemental content is presented to the user automatically when the user interacts with the computing device, e.g., when performing a flick or swipe gesture which simulates flipping the page over, among other possible user interactions. In some embodiments, the look and feel of the page (including design, colors, font, etc.) may be preserved when the flip operation is performed to create an impression that the back side of the page is part of the same site.

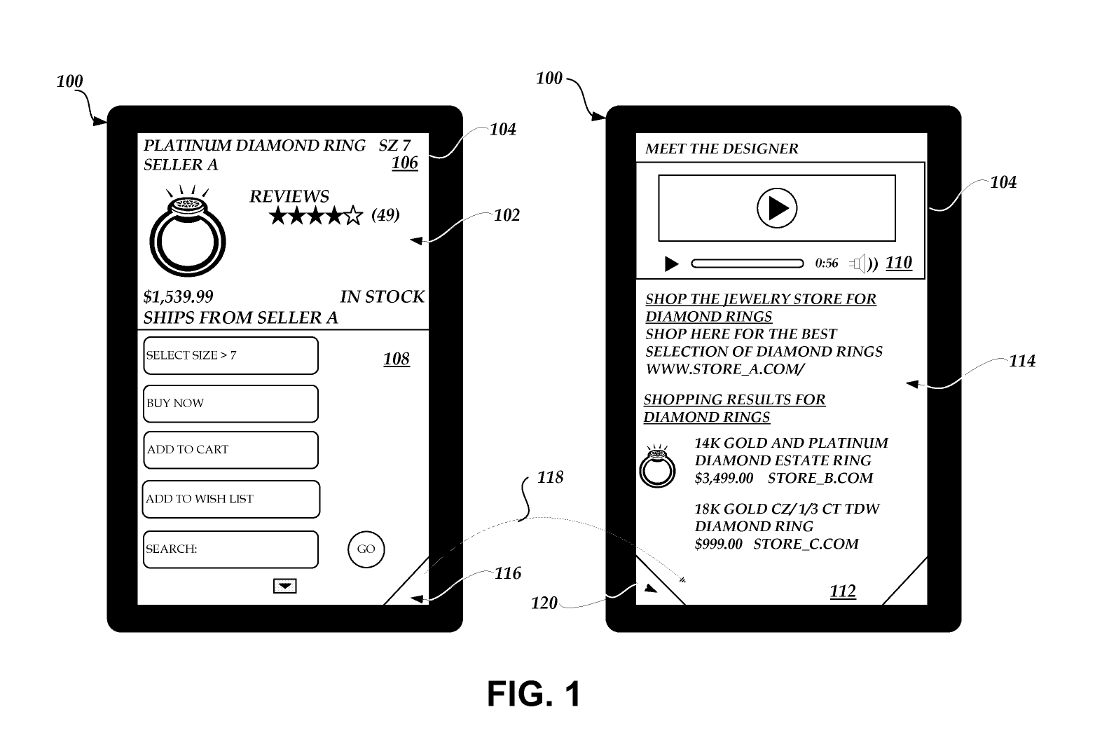

FIG. 1 depicts a practical example of a presentation of such supplemental content in a flipped page following detection of a user interaction with a computing device 100, the detection occurring while the content item is being displayed in a first page on the display. In FIG. 1, an initial content item 102 is presented in a first page on a display 104 of a computing device 100, for example via a browser application. In the illustrated example, the content item 102 is a webpage describing an item available for purchase from a retail website. More specifically, in the illustrated example, the item available for purchase is a platinum diamond ring and the webpage includes information 106 related to the ring, such as an image of the ring, a customer review rating for the ring, seller data, price data and availability data. In addition, in the illustrated example, the webpage includes various software selection/controls 108 for purchasing the ring, adding the ring to an electronic shopping cart or wish list and searching for related items available for purchase.

The illustrated user interface also provides a flip indicator 116 in the bottom right corner of the display 104, to indicate that the page may be flipped over to view supplemental content associated with the content item 102. In other embodiments the flip indicator may appear in any corner or side of the display, or the flip indicator may be an icon or some other visual indicator appearing anywhere on the display. In some embodiments, the browser may modify the visual appearance of the flip indicator with movement or animation to reveal to the user that the page may be flipped over. Thus in the illustrated example, the bottom right corner may be animated to “peel back” slightly when the page is initially displayed, in order to indicate to the user that the page may be flappable. In some embodiments the flip indicator may only be presented when supplemental content is available for the particular page or content item 102 being viewed. When the user interacts with the computing device 100 (e.g., when the user flips the page as described herein) as indicated by the direction of arrow 118, and such interaction is detected, supplemental content 114 (also referred to as page metadata) is automatically presented in a second, flipped page on the display 104 of the computing device 100. Further, in response to a user interaction to flip the page, such as via a touchscreen gesture, the browser may create a visual appearance of the content page being flipped over to reveal the back side (e.g. the flipped page). The illustrated supplemental content 114 includes, for example, video content 110 related to the ring, as well as search results 112 related to the ring. As will be appreciated from the illustrated example, a user who is browsing a website may automatically be presented with additional information related to a webpage (or contents within a webpage) simply by flipping the page, and thus, the user is not required to actively search for such information. This can result in intuitive and more efficient navigation of information related to the content item and/or of interest to the user, without requiring affirmative input by the user. Moreover, presenting the supplemental content item in an alternative or flipped page may allow for a more aesthetically pleasing presentation of the content item than in the first page, and enable the user to delve deeper into certain content.

In some embodiments, and as illustrated in FIG. 1, the user interface for the flipped page may also provide a reverse flip indicator 120, for example in the bottom left corner of the display 104, to indicate that the page may be flipped back to the first page presenting the content item 102. Further, in some embodiments, the user the user interface for the flipped page may also provide an additional flip indicator, for example in the bottom right corner of the display 104, to indicate that the page may be flipped over again multiple times to present additional levels of supplemental content and/or page metadata related to the supplemental content 114 and/or the content item 102. Thus the user may be given the option to flip pages “forward” a virtually unlimited number of additional supplemental content pages or items, and the option to flip pages “backward” to return to prior flipped pages and/or the first page. In some embodiments, rather than provide a separate reverse flip indicator the user may be given the option to use the browser's back button to reverse flip, or flip pages backward, as described above. The option to use the browser's back button in this way may also be a user-configurable setting. The browser may display two types of “back” buttons or controls when the user flips multiple levels into the page: a single-level button for going back one level, and a “return to original page” button for going back multiple levels to the original page that was flipped.

The supplemental content 114 is typically, but not necessarily, provided by a data source (or combination of data sources) other than the source of the content page 102. For instance, in the example of FIG. 1, the supplemental content 114 may be supplied by an entity that operates independently of the retail website, without the involvement of the site's owner or operator. Thus, the disclosed interface may be used to present supplemental content for virtually any page or content item, including preexisting web pages.

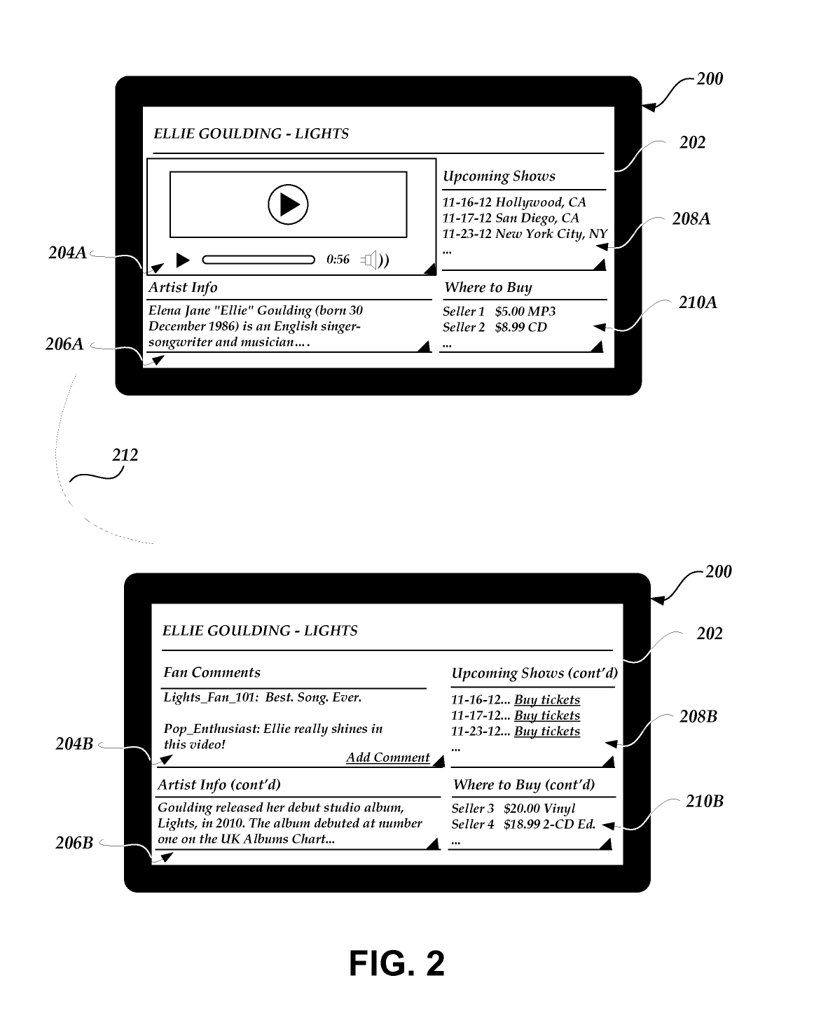

Another practical example of presentation of supplemental content in accordance with the present disclosure is illustrated in FIG. 2. As depicted in FIG. 2, various initial content items 204A (e.g., a music video in the illustrated example), 206A (e.g., information about the artist), 208A (e.g., information about upcoming shows by the artist), and 210A (e.g., information about where to buy the music featured in the video) are displayed in a first page on a display 202 of a computing device 200. In this example, each of the content items 204A, 206A, 208A, and 210A are presented on different panels or portions of the first page which may be individually flipped to view supplemental content. When the user interacts with the computing device 200 (e.g. by flipping one or more of the panels corresponding to the content items 204A, 206A, 208A and 210A), as indicated by arrow 212, supplemental content items 204B, 206B, 208B and 210B to the content items 204A, 206A, 208A and 210A are presented in flipped panels on the display 204 of the computing device 100. In the illustrated example, the supplemental content items 204B, 206B, 208B and 210B may include some of the content items 204A, 206A, 208A and 210A previously presented on the display 204, as well as additional information related to the content items 204A, 206A, 208A and 210A and/or of possible interest to the user. The depicted supplemental content/additional information includes metadata 204B related to the music video, such as a fan comments (as depicted in FIG. 2) and the ability for the user to add her own comment. In some embodiments, the back side of the page may also include a form or text entry box for the user to enter and submit comments associated with the page or content item. These user-entered comments may then be presented to other users viewing the back side of the page.

Other types of metadata 204B (not shown) for the music video may include, for example, customer review ratings, information about the production of the music video, another version of the music video (e.g. a director's cut, artist commentary, behind-the-scenes, live versions, remixes, etc.) and so on. Although FIG. 2 depicts each panel corresponding to content items 204A, 206A, 208A and 210A in a “flipped” state to present supplemental content items 204B, 206B, 208B and 210B, this is merely to illustrate that multiple panels may be in different flipped states concurrently. Thus in other examples, any number of flippable panels may be in a flipped state at any given time, allowing the user to access additional content and information while still viewing the original content items. For example, the user may want to flip through one or more of the panels 206A, 208A and 210A to access and view supplemental content while continuing to watch the music video at content item 204A (e.g., the user may not flip the panel corresponding to content item 204A). In some examples the user may flip back and forth among multiple content item panels while the first page as a whole continues to be displayed. However, other scenarios may also be possible. For example, the display and/or user interface may present an option for the user to flip a single panel (e.g., content item 206A presenting a summary of artist information) of the first page and present a second page replacing the view of the first page with supplemental content (e.g., content item 206B with expanded or more detailed artist information) related to or associated with the content item of the single panel. In each of the specific examples described above, the user may have the option to flip the page or panel forward any number of times to view different supplemental content, as well as the option to flip the page or panel back to view the original content item.

Although specific examples are provided in FIGS. 1 and 2, those skilled in the relevant art will appreciate that the supplemental content may include virtually any type of information that may be related to the initial content item and/or be of interest to the user and that a content item may include any form of digital content. Accordingly, the terms “content,” “digital content” and “content item” are interchangeable herein. Examples of content items include, but are not limited to, music, songs, albums, movies, television shows, television broadcasts, radio broadcasts, videos, video games, documents, audio books, electronic books (“eBooks”), images, maps, articles, webpages or other multimedia works. Supplemental content for such content items may also include digital content, e.g., movies, webpages, documents, etc. and can provide additional information regarding the content item. In some embodiments, the supplemental content includes information typically presented with or as part of the content item in the first page, but this supplemental content is perhaps removed from the presentation in the first page so as to simplify or “de-clutter” said presentation. U.S. Pat. Nos. 7,159,023, 8,145,542, and 8,271,878, the disclosures of which are incorporated by reference, describe some of the many types of metadata that can be presented using the disclosed user interface, and describe methods that may be used to generate or obtain such metadata.

Although described as supplemental content or secondary content, it should be understood this content could include a different form of the initial content. In some embodiments, the supplemental content could be a different version, format or size of the initial content. For example, the supplemental content could be a version of the original content in a different resolution (e.g. a mobile view, a table view, a desktop view, etc.) or displayed using 3D technology. The information may then be presented on the display 104 in the flipped page following user interaction with the computing device 100. In other embodiments, the supplemental content information includes information obtained independently from the content item. In some embodiments, the supplemental content may be displayed to the user in the flipped page with the original content or, in other embodiments, may be displayed on its own. Supplemental content may also include website-level metadata (e.g., related websites, website traffic rank, the date/time when the website was created or published, etc.). In some embodiments this website-level metadata may be presented to the user when the user flips the home page associated with the website. In some embodiments, the size of the back side of the page may be fixed, or capped, so that a limit may be placed on how much supplemental content can be displayed.

Supplemental content may also include advertising content provided by content or service providers such as reviews (e.g. of products or services), channels (e.g. product and/or service review websites, multimedia review channels, “how to” channels, and the like) and advertisements related to a content item presented in the first page. For example, a first page may present an article related to a particular product (e.g., a car), and supplemental content may include an advertisement for that product (e.g., an ad for the car, a video review about the car) which may be text-based, graphical, audio-visual, interactive, and so on. The supplemental content may also provide options for the user to view and/or flip the page for more information about the product, such as technical specifications, additional user reviews, suggestions or recommendations on where the product may be available for purchase. Some or all of the supplemental content may be targeted for the user based on, for example, their location (e.g., suggestions on where to buy may be based on the user's location) and/or other demographic information (e.g. age, gender). In some embodiments, content or service providers may be able to associate certain supplemental content (e.g., a channel, an advertisement, an advertisement incentive such as a coupon or reward, an application, etc.) with a content item, and to bid to have their supplemental content provided for display on a flipped page or panel corresponding to the content item. The provider of the overall system may also provide incentives to users for flipping over pages and/or page elements, such as by occasionally revealing a prize or discount offer on the back side of a flipped page or page element.

The ads and other supplemental content presented to a user on the back side of the page may be selected dynamically from a pool of supplemental content associated with the page. In such embodiments, a history of the user's past flip operations may be taken into consideration in deciding what supplemental content to present. In some embodiments, ad content may be associated with keywords or a certain series or sequence of flips events. The overall system may also track the series or sequence of flips and select ads based on a specific pattern in the series or sequence. Further, in some instances, when a user selects an ad on the back of a page, the browser may create the appearance that the page is being flipped over an additional time to reveal the target (advertiser) page associated with the ad. In some embodiments, an ad may itself be flippable to reveal further supplemental content associated with the ad, such as corresponding ad or advertiser metadata, such as an average rating of the advertiser.

Given the above, one can provide an almost limitless number of practical examples in which aspects of the present disclosure may be implemented. For instance, with respect to the example illustrated in FIG. 1, the supplemental content 114 may include information that may be removed from the webpage presented in the first page in order to simplify the presentation or make the presentation more aesthetically pleasing. For instance, the price data, customer review rating, seller data, availability data and software controls could be removed from the webpage and instead included in the supplemental content. Accordingly, only the image and brief description of the ring offered for purchase on the webpage may be presented in the first page to the user. With respect to the example illustrated in FIG. 2, the supplemental content 204B, 206B, 208B and 210B may include additional information that is related not only to the music video presented in the first page, but to the particular artist presented in the first page. Although FIGS. 1 and 2 each depict only two pages (e.g., a first page and a flipped page, or a first page with one or more flipped panels), in some embodiments additional pages presenting different supplemental content can be provided when the device is flipped any number of times (e.g., as the user might, for example, while “flipping” through a book or a catalog). In one example, different supplemental content can be displayed if device 100 is flipped in different directions (e.g., from left to right, right to left, top to bottom, bottom to top, etc.).

There are myriad user interactions that can be implemented within the browser or computing device to enable users to “flip the page” and trigger the presentation of a supplemental content in a flipped page. For example, such presentation may be triggered based detection of an audible command, image detection of a user gesture, selection of an existing software control (e.g., dragging of a scroll bar), detection of a touchscreen gesture with the display (e.g. touching a corner or predetermined area of the display, swiping from one edge or corner to another, a swipe gesture in which a representation of a corner of the content page is dragged away from a corner of the touchscreen, touching and dragging a corner to simulate “peeling” a page corner back to flip the page, long-press followed by a swipe gesture, pinching or squeezing two or more fingers on an area of the display, etc.), a keyboard action (e.g., pressing a “page down” key) or some other manipulation of an input device (e.g., flicking the computing device quickly to the left, right, up or down to simulate a “flipping” action, rotating, shaking, tilting and/or spinning of the computing device, etc.). In some embodiments the display of the computing device may expose the possibility of different user interactions on a single page to allow the user to flip to different pages. For example, the single page may allow the user to swipe from right-to-left to flip to a first flipped page, swipe from left-to-right to flip to a second flipped page (or to reverse flip back to the first page, or to a previous flipped page in a series or stack of flipped pages etc.), and so on. In some embodiments, when the user flips the page, the browser may use animation to create the appearance of a physical page being flipped over to expose its back side. The browser may additionally or alternatively support other user actions for causing the supplemental content to be displayed. For example, the user could swipe the original page to the side to cause the “supplemental content” page to slide-in in place of the original page. As another example, the user could perform a gesture that causes an overlay page containing the supplemental content to be displayed over the original page.

As mentioned above, in some embodiments the user may be presented with the ability to flip certain panels or portions of a first page, either instead of or in addition to the ability to flip the first page as a whole. The panels or portions may for example correspond to particular content items presented on the first page. Supplemental content associated with the particular content item for a panel may be presented in response to detection of a user interaction to flip the panel. In such an example, only the particular panel may be flipped, replacing the particular content item with the associated supplemental content, while the rest of the first page remains in the same visual state as before the flip. In some cases the user may be allowed to flip more than one panel of the first page, either sequentially or in parallel. In some cases the user may be allowed to “unflip” (e.g., reverse flip) a panel back to its original “unflipped” visual state, and in some cases the user may be allowed to flip a panel multiple times to view additional supplemental content. Further, in some cases the user may be allowed to flip and/or reverse flip one or more panels from a first visual state to a second visual state, then flip the page to view different supplemental content, and then reverse flip the page back view to the second visual state. The display of the computing device may be configured to detect any possible combination of user interactions to present the virtually unlimited number of display states involving one or more flipped panels and/or pages. As described herein, embodiments describing flipping the page shall be understood to include and cover embodiments or variations involving flipping a panel or portion of the page, or combinations thereof.

The display may also present various user interface features to indicate to a user whether and how a page or panel may be flipped. For example, in some embodiments a corner of the display may present a triangular and/or three-dimensional representation of the upper right corner (or any corner) of the page (or panel) slightly peeled back to provide an indication to the user that can flip the page (or panel) by touching that corner and swiping away from the corner edge to simulate peeling the page (or panel) back in order to flip the page (or panel). In other embodiments, the display may provide an indication or suggestion that flicking the device quickly to the left (or any direction) may flip the page, much as one would physically flip a card or piece of paper to see what is on the other side. In some embodiments the display may also present an indication that no supplemental content is available for a page or panel, for example, by greying out and disabling a display element ordinarily used to flip the page, or by not presenting the display element altogether.

In some embodiments the display may also be configured to present an icon or other graphic to provide the user with a visual indication or preview of the type of supplemental content that may be available on the flipped page or panel. For example, content presented in a first page on the display may be a textual article or review about a product, while supplemental content available on the flipped page may be a gallery of images of the product. In this example the display may present a “gallery icon,” for example in one corner of the first page display, to provide an indication that the user may flip the page to view the gallery of images of the product. Any type of icon or other graphic may be presented depending on the type of supplemental content available, including but not limited to a video icon to indicate video content, a text icon to indicate additional text icon, a comment icon to indicate comment-based content (e.g., view user comments, and/or the ability for the user to comment and/or provide annotation on a content item or page), a music icon to indicate music-based content, a question mark icon to indicate search or query based content, and so on.

As yet another example, the content item presented in the first page on the display of the computing device may be an image or movie clip of a person, place or object, and the supplemental content item may include video or audio content featuring the person, place or object; biographical or historical information regarding the person, place or object; links to other information relating to or referencing the person, place or object; other images of the person, place or object; search results for the person, place or object; etc. Accordingly, whenever a user flips the computing device (or otherwise interacts with the computing devices as described below in other embodiments) while the image of the person, place or object is being presented in a first page on the display of the computing device, such supplemental content is automatically presented in a flipped page on the display without requiring the user to actively seek the information included in such supplemental content.

In another example, a student may use a device to read text displayed on a first page. When the student “flips the page” the student may, for example, see a video related to the text. If the student flips the page again to a third page, a test could be presented to the student. When the student has completed the test or finished watching the video, the student may flip the page back to the first page. While this example describes a first page and two flipped pages, any number of flipped pages may be available and presented for display. Further, in some examples, certain panels or portions of the page may be flipped by the student. For example, the third page presenting a test to the student may include one or more panels for each question on the test, which the student may selectively flip to view the answer to the question and/or explanation of the answer.

In other example, a user may use a search engine to perform a web search for content matching certain search criteria. The first page may present search results, for example, links to content matching the search criteria. The display may provide an option for the user to flip the page to view supplemental content such as an indication of which links in the search results are “better quality” based on various criteria (e.g. click-through rates, how long users stayed on a page corresponding to a particular link, etc.). In another variation of this example, supplemental content may also present search results from different search engines, suggested or related search terms, information about trending topics for the search criteria or related searches, and so on. In another variation, panels corresponding to particular search result items may be flipped to display supplemental content such as a quick preview of a search result item or other information related to the search result item (e.g. about the web site, when the search result item was published).

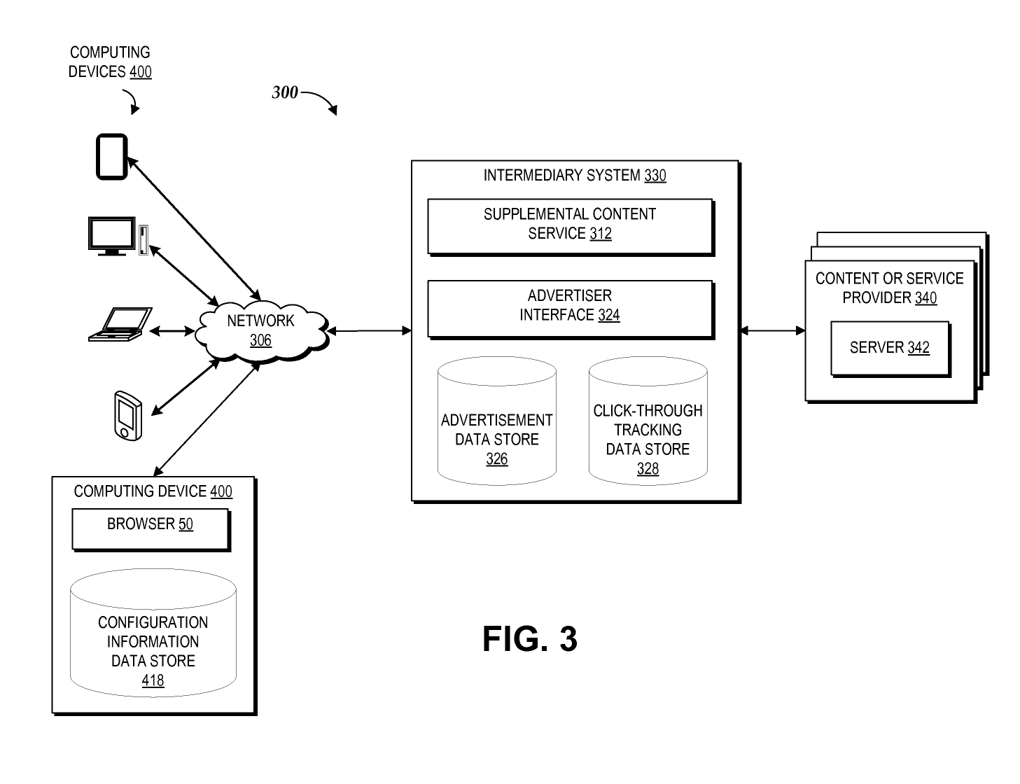

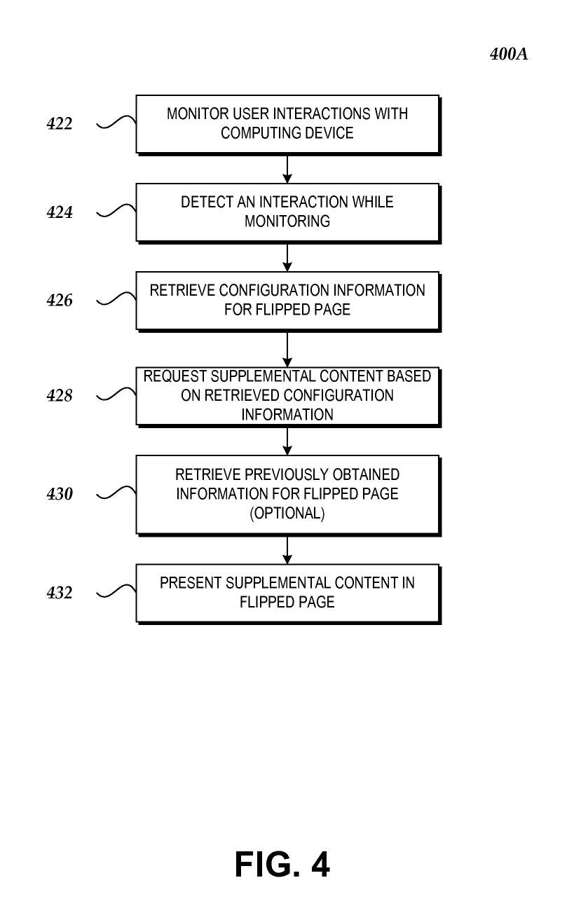

FIG. 3 is a block diagram illustrative of an operating environment 300 capable of operating as described herein. The operating environment 300 may include an intermediary system 330 which serves as an intermediary between computing devices 400 and content or service providers 340, such as web sites. The computing devices 400 that access the content or service providers 340 can include various types of computing devices, such as tablets, mobile phones (including smartphones), electronic book readers, desktop computers, laptop computers, personal digital assistants (PDAs), other wireless devices, set-top or other television boxes, media players, game platforms and kiosks, among others. Illustrative components of computing devices 400 are described in greater detail with reference to a computing device 400 as described in paragraphs [0021] to [0030] and as illustrated in FIG. 4 of the '193 application incorporated by reference herein.

In some embodiments, the intermediary system 330 may, for example, be or act as a proxy server, a partial rendering engine for specific browsers or device types, a CDN, an Internet Service Provider (“ISP”) system, or a combination thereof. Each computing device 400 runs a browser application 50 (“browser”) capable of retrieving and displaying content pages according to standard protocols. The browsers 50 may be designed or configured to retrieve web pages via the intermediary system 330. In some embodiments, each computing device 400 may include a configuration information data store 418 that stores information used by the computing device 400 to configure the presentation of supplemental content in one or more flipped pages following detection of user interaction with the computing device 400 in accordance with the present disclosure. Such configuration information may include, but is not be limited to, metadata associated with the content item presented in the first page, watermarking data associated with the content item presented in the first page, contextual data associated with the content item presented in the first page, user supplied configuration data, third party supplied configuration data, user profile data, device profile data, content profile data and the like. The computing device 400 may, for example, retrieve configuration information from the configuration information data store 418 in response to a user interaction to flip the page in order to obtain supplemental content related to the content item to be presented in the second flipped page. In one embodiment, the configuration information identifies what information is to be included in the supplemental content.

In some embodiments, the features and functionality disclosed herein can be implemented collectively by the browser 50 and intermediary system 330. For example, when the browser 50 requests a page (or content item) from a URL through the intermediary system 330, the intermediary system 330, in addition to returning the requested page (or content item), may return a second page (or other unit of content) containing metadata for the requested page. The browser 50 may then store this second page and/or page metadata in a local cache, and would present it via the display in response to the user performing a flip operation. Alternatively, the browser 50 can request and retrieve the metadata page from the intermediary system 330 when the user initiates the flip operation.

The user interfaces and features disclosed can be implemented without an intermediary system 330. For example, when the browser 50 requests a page from a URL, the browser 50 can concurrently send a request to a metadata server for the metadata associated with the requested page and store the metadata in its local cache for later display in response to a user flipping the page.

In some embodiments, the browsers 50 may be (or may include) conventional web browsers that are not specifically designed or configured to display page previews. In other embodiments, the browsers 50 may be specifically designed to handle specific tasks associated with the display of page previews.

The content or service providers 340 may include or consist of, for example, ordinary web sites and/or web services. Each content site 34 may include a server 342 that serves content, such as web pages, in response to URL requests. The pages for which supplemental content may be generated can be conventional web pages that do not include any special coding or formatting to support the generation of supplemental content as described herein. In some embodiments, however, the intermediary system 330 may support the use of special tags for designating whether or how supplemental content should be generated for particular pages. Where special tags are supported, a content provider may, for example, embed tags in a content page indicating, for example, which visual elements or sections of the page should be associated with supplemental content.

As shown in FIG. 3, the intermediary system 330 includes a supplemental content service 312, an advertiser interface 324 an advertisement data store 326 and a click-through tracking data store 328. (In some embodiments, the advertiser interface 324, the advertisement data store 326 and the click-through tracking data store 328 are omitted.) The supplemental content service 312 obtains and/or generates supplemental content related to a content item in response to a request from the computing device 400. As described herein, the supplemental content may be associated with one or more content items being presented in a first page (or panel) on the display of the computing device 400 and is configured to be presented in a flipped page (or panel) on the display of the computing device following user interaction with the device. Moreover, the supplemental content item may itself be, for example, a webpage, a document, an image, a software application, etc. or may be an overlay of information that is presented in conjunction with the content item.

The advertiser interface 324 allows an advertising entity, including in some embodiments content or service providers 340 and/or other third-party advertisers, to associate supplemental advertising content (e.g., a channel, an advertisement or ad, a coupon, an application, etc.) with a content item. In some embodiments the advertiser interface 324 may allow the advertising entity to associate supplemental content with keywords which may be related to the content item. Supplemental advertising content associated with a content item may also include, for example, particular pages or web Universal Resource Locators (“URLs”), and/or classes of pages or web URLS for the content item. The advertiser interface 324 may also allow the advertising entity to place a bid to have their supplemental content displayed on a flipped page or panel corresponding to the content item. The bid may include various parameters such as a bid price, a number of times the supplemental content is to be displayed or made available on a flipped page or panel, a time of day at which the supplemental content is to be displayed or made available on a flipped page or panel, desired target characteristics of users who may presented the supplemental content (e.g., demographic information such as age, gender, location, etc.). The intermediary system 330 or browser 50 may then select supplemental content associated with content items to be displayed based, for example, on the highest bid amount and/or other parameters associated with the bid. For example, in one embodiment the browser 50 may maintain a number of ads in a local cache, and dynamically select ads from the cache to display on flipped pages based on keyword matching or any other criteria. In some embodiments, the advertiser interface 324 may include a website or an area of a website hosted by a server.

The advertisement data store 328 may store advertisements (and other supplemental content) uploaded by the advertising entity to enable quick and efficient retrieval by the intermediary system 330 or browser 50. The click-through tracking data store 328 may, for example, record flip events, click-through events for advertisements, and other supplemental content for purposes of charging the advertising entity a fee. Additionally, according to one embodiment, the browser 50 may report page flip user interaction events to the intermediary system 330, and the intermediary system 330 may use these reported flip events to log advertisement impression events for any ads displayed on the back of the page. In some embodiments the advertising entity may be charged for the advertisement impression events. One benefit or this approach is that it does not require the involvement of, or payment of money to, the operators of the websites on which the ads are effectively being displayed.

Another illustrative example of an operating environment 300 and various components according to some embodiments are described in greater detail with reference to the operating environment 300 as described in paragraphs [0014] to [0020] and as illustrated in FIG. 3 of the '193 application incorporated by reference herein. Any and all of the components of the operating environment 300 as described in the '193 application may be included in the operating environment 300 described in the present disclosure, including, for example, an application service 310, an application data store 304, a supplemental content data store 314 and network data source(s) 302 and any number of additional components, systems and/or subsystems as described in the '193 application. Further, in some embodiments, the supplemental content data store 314 as described in the '193 application may be local to the supplemental content service 312, may be remote from the supplemental content service 312, may local to the content or service provider 340 and/or may be a network-based service itself.

Further, the supplemental content service 312 as illustrated in FIG. 3 of the present disclosure may include additional components, systems and/or subsystems as described in the '193 application, to obtain and/or generate supplemental content. For example, components of the supplemental content service 312 may include a computing device interface 320 for receiving and transmitting requests for supplemental content from computing device 400, an external data source interface 316 for obtaining supplemental content information from network data sources 302 and an application service interface 322 for obtaining applications which may be supplemental content from application service 315. The supplemental content service 312 can further include a content request processing component 318 for processing requests for supplemental content received from one or more computing devices 400, generating requested supplemental content and ultimately publishing supplemental content.

### Process for Flipping a Page to View Supplemental Content (FIG. 4)

FIG. 4 illustrates one embodiment of a process 400A for obtaining a supplemental content item to be presented on the back of a first page. In one embodiment, the process 400A is implemented by the computing device 400 (e.g., via the browser 50 as illustrated in FIG. 3 herein and/or via the user interface component 412 as described in the '193 application). The process 400A begins in a block 422 in which interactions between the user and user's computing device are monitored (e.g., via the monitoring component 413 of the computing device 400 as described in the '193 application). In one embodiment, the monitoring component 413 monitors interactions between the user and the computing device while content items are being presented in a first page with respect to the display 406 of the computing device 400. Once such an interaction (e.g., such as one of the user interactions the user may perform to flip the page or a panel of the page) is detected in a block 424, configuration information may be retrieved in block 426 (e.g., from the configuration information data store 418 described with reference to FIG. 3). The retrieved configuration information may describe how and what supplemental content information is to be presented in the flipped page or panel on the display 406 of the computing device 400. In the illustrated method, once the configuration information is retrieved, supplemental content is requested in block 428 based on the configuration information. In other embodiments, once the configuration information is retrieved, page metadata may be automatically retrieved by the browser 50 in the background after the first page has loaded, so that the page metadata may be readily available for display if the user initiates a flip. Additionally in some embodiments, the browser 50 or intermediary system 330 may be configured to predictively determine whether supplemental content and/or page metadata may be pre-fetched or pre-forwarded based, for example, on how frequently the user invokes the flip the page feature.

As described above, the supplemental content service 312 may provide the supplemental content to the computing device in response to this request. In some embodiments, previously obtained supplemental content information may also be retrieved for inclusion in the supplemental content for presentation in the flipped page in a block 430. Next in block 432 the computing device 400 may present the supplemental content in the flipped page, or in the flipped panel of the first page, on the display 406 of the computing device 400.

As a result of process 400A, the supplemental content for the initial content item is automatically presented in the flipped page or panel following detection of user interaction with the computing device 400, the detection occurring while the content item was being presented in the first page on the display of the device. Thus, supplemental content may be made accessible via an intuitive user interface presented on the display of the device, in a manner which does not substantially reduce the amount of screen “real estate” available for display of the first page (e.g., through the utilization of small, unobtrusive and intuitive flip indictors as described with reference to FIGS. 1 and 2 above), This feature is particularly beneficial for devices such as tablets and smartphones with smaller screen resolutions. The automatic presentation of the supplemental content also frees the user from affirmatively seeking or searching for the information contained in the supplemental content. In addition, the supplemental content enables the provider of the content to avoid including superfluous information related to the content item when the content item is presented in a first page. Following presentation of the supplemental content in the flipped page, the method 400A may end.

### User Configuration

In some embodiments, a user can configure the presentation of supplemental content in a flipped page. In one embodiment, a user may utilize a supplemental content configuration user interface of a configuration application to configure how and what information is to be included in supplemental content that is to be presented in a flipped page. The configuration application may, for example, be hosted by the intermediary system, and/or may be accessible via a menu option of the browser 50.

Some examples of supplemental content configuration options may include what types of supplemental content should be displayed (e.g., ads, site-level data, links to related sites, product metadata, price comparison data, product recommendations, user comments, etc.), which content provider(s) should the supplemental content be obtained from, whether the supplemental content should be retrieved and cached preemptively in the background (e.g., always or when Wi-Fi is available), whether to enable the intermediary system to deliver personalized metadata based on the monitored behaviors of the user, and the like. Additional examples of supplemental content configuration options and sample user interfaces and processes are described in greater detail in the '193 application incorporated by reference herein, in particular paragraphs [0040] to [0045] and FIGS. 7A-7C. While the examples described in the '193 application are provided with respect to a user rotating the computing device from a first orientation to a second orientation, the examples are equally applicable to the present disclosure with respect to a user flipping the page as described herein. For example, references to “when the device is rotated” or “when you rotate your device” with regard to FIGS. 7A-7C of the '193 application may be replaced with references to “when the page is flipped” or “when you flip the page” to illustrate how a user may configure the presentation of supplemental content in a flipped page.

### System Implementation and Variations

The intermediary system 330 may be implemented by or on a computing system that comprises one or more physical computing devices (physical servers, storage arrays, routers, etc.), each of which may include a processor and memory. The computing system may, in some cases, include computing devices that are distributed geographically, in which case some of the disclosed server-side tasks may be performed remotely from others. The various functions of the intermediary system 330 may be embodied in code modules executed by the computing system. The code modules may be persistently stored on any type or types of non-transitory computer storage devices or media (magnetic disks, solid state memories, optical drives, etc.). Some or all of the disclosed processes of the intermediary system 330 may alternatively be embodied partly or wholly in specialized computer hardware, such as in custom designed ASICs or FPGAs. The various components and functions of the intermediary system 330 can also be implemented in one or more virtual machines or cloud resources, rather than in dedicated servers. The browser 50 may include executable code stored on any type of non-transitory storage medium, including code for implementing the client-side functions (including the various user interface features) described herein.

In some embodiments, the intermediary system 330 may be omitted. In such embodiments, the intermediary system 330 may alternatively be implemented on a separate network-accessible server system that does not act as an intermediary between the browsers 50 and content sites 340. Further, as described herein, supplemental content could alternatively be generated by the browsers.

Although described in the context of content “items” or “pages,” the methods disclosed herein are also applicable to other documents and units of content. For example, the disclosed methods can be used to provide supplemental content related to Word documents, spreadsheet files, PDF documents, and various other types of documents.

Although described in the context of a browser, the user interfaces disclosed herein can also be implemented within other types of document viewers capable of retrieving and displaying documents. For example, the user interfaces may be implemented within a word processing program, a PDF reader, or a news reader.

The disclosed features may also be incorporated into other types of mobile applications, including news reader and e-book reader applications. For example, the user can flip over a news story page to view links to related stories, a biography of the reporter, ads associated with keywords appearing in the story, etc.

### CONCLUSION

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list.

Conjunctive language such as the phrase “at least one of X, Y and Z,” unless specifically stated otherwise, is to be understood with the context as used in general to convey that an item, term, etc. may be either X, Y or Z, or a combination thereof. Thus, such conjunctive language is not generally intended to imply that certain embodiments require at least one of X, at least one of Y and at least one of Z to each be present.

While the above detailed description has shown, described and pointed out novel features as applied to various embodiments, it can be understood that various omissions, substitutions and changes in the form and details of the devices or algorithms illustrated can be made without departing from the spirit of the disclosure. As can be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. A system for enabling users to view supplemental content associated with pages of content sites, the system comprising:
a server system that stores advertisements in association with particular content pages of content sites, said server system comprising one or more physical servers; and
a browser component that is configured to run on user computing devices, said browser component including executable code that directs a user computing device to perform a process that comprises:
receiving, over a network, a content page of a content site, and displaying the content page on a touchscreen of the user computing device;
receiving, from the server system, one or more advertisements associated with the content page;
detecting a touchscreen gesture representing a user request to flip the content page over; and
in response to the touch screen gesture, creating a visual appearance of the content page being flipped over to reveal a back side, and displaying the one or more advertisements on said back side.

2. The system of claim 1, wherein the server system includes a user interface that includes functionality for an advertiser to submit an advertisement, and to designate at least one content page for which the advertisement is to be displayed on a back side.

3. The system of claim 1, wherein the advertisement comprises at least on one of multimedia content, a product advertisement, a service advertisement, an advertising channel and an advertisement incentive.

4. The system of claim 1, wherein the server system is configured to receive, from an advertising entity, a bid to provide, to a user computing device, an advertisement associated with a particular content page.

5. The system of claim 1, wherein the browser component is configured to report a page flip event to the server system in response to the gesture, and the server system is responsive to the page flip event by recording an advertisement impression event in connection with each of the one or more advertisements.

6. The system of claim 1, wherein the browser component is configured to report a series of page flip events to the server system, and the server system is responsive to the reported series of page flip events by selecting the advertisement based at least partly on a particular pattern in the series of page flip events.

7. A non-transitory storage medium having stored thereon a browser component, said browser component including executable code that directs a user computing device having a touchscreen to perform a process that comprises:
retrieving a content page of a content site, and displaying the content page on the touchscreen;
receiving, from a content source that is separate from the content site, advertising content associated with the content page;
detecting a touchscreen gesture representing a user request to flip the content page over; and
in response to the touchscreen gesture, creating a visual appearance of the content page being flipped over to reveal a back side, and displaying advertising content on said back side.

8. The non-transitory storage medium of claim 7, wherein the touchscreen gesture is a swipe gesture in which a representation of a corner of the content page is dragged away from a corner of the touchscreen.

9. The non-transitory storage medium of claim 7, wherein the process further comprises, while the back side of the content page is displayed, detecting a second touchscreen gesture representing a second request to flip the page over, and responding to the second touch screen gesture by creating a visual appearance of the page being flipped back to reveal a front side.

10. The non-transitory storage medium of claim 7, wherein the process further comprises, while the back side of the content page is displayed, detecting a second touchscreen gesture representing a second request to flip the page over, and responding to the second touch screen gesture by creating a visual appearance of the page being flipped to reveal advertiser information.

11. The non-transitory storage medium of claim 7, wherein the advertising content includes links to related pages of other content sites.

12. The non-transitory storage medium of claim 7, wherein the browser component is configured to receive and cache the advertising content in the background prior to detection of the touchscreen event.

13. The non-transitory storage medium of claim 7, wherein the browser component is configured to receive the advertising content over a network from an intermediary system that serves as an intermediary system between the browser component and the content site.

14. The non-transitory storage medium of claim 7, wherein the browser component includes functionality for a user to specify, via configuration settings, types of advertising content to be displayed on back sides of content pages.

15. A system for providing advertising content, the system comprising:
one or more data stores that store advertising content data; and
a browser component including executable code that directs a user computing device operative to:
detect a user interaction with the user computing device, wherein the user interaction is indicative of a request to flip a first page presented on a display of the user computing device over to a second page, wherein the user interaction occurs while an initial content item is being presented in the first page; and
automatically present advertising content in the second page on the display after detection of the user interaction; and
a computing device in communication with the one or more data stores, said computing device operative to:
receive, from a first remote computing device, a request to associate a content item with advertising content data and a bid;
associate the content item with the advertising content data;
receive, from a user computing device, a request for initial content data;
obtain the initial content data and advertising content data associated with the initial content data from the one or more data stores; and
transmit the initial content data and the advertising content data to the user computing device.

16. The system of claim 15, wherein the user interaction is a touchscreen gesture in which a representation of a corner of the content page is dragged by the user away from a corner of the display.

17. The system of claim 15, wherein the initial content comprises at least one of multimedia content, a webpage, a document, an image and a software application.

18. The system of claim 15, wherein the advertising content data comprises at least one of a product advertisement, a service advertisement, an advertising channel and an advertisement incentive.

19. The system of claim 18, wherein the advertising channel comprises at least one of multimedia content, a webpage, a document, an image and a software application.

20. The system of claim 15, wherein the first page is presented on a portion of the display and the second page is presented on the portion of the display, and wherein the advertising content is automatically presented by presenting the second page instead of the first page on the portion of the display.

21. The system of claim 15, wherein at least one of the one or more data stores comprises an external data store from which data is obtained via one or more application programming interfaces.

22. The system of claim 15, wherein the bid is a bid to provide the advertising content data to a plurality of remote computing devices in response to a request from the plurality of remote computing devices for advertising content data associated with the content item, and wherein said computing device is further operative to obtain the requested advertising content data from the one or more data stores based at least in part on the bid.

23. The system of claim 15, wherein the bid comprises at least one of a bid price, a number of times the advertising content data is to be provided to a remote computing device, a time of day at which the advertising content data is to be provided to a remote computing device and a set of characteristics of users of remote computing devices to which the advertising content data is to be provided.

24. The system of claim 15, wherein the initial content data is optimized for a first screen resolution and the advertising content data is optimized for a second screen resolution.

25. The system of claim 24, wherein the first screen resolution is optimized for presentation on a display of a desktop computer and the second screen resolution is optimized for presentation on a display of a mobile computing device.

26. The system of claim 15, wherein said computer device is further operative to:
associate the content item with the advertising content data based at least on one of metadata associated with the content item, watermarking data associated with the content item, contextual data associated with the content item, user supplied configuration data, user profile data, content profile data, device profile data and third party supplied configuration data.
